(19) United States
(12) Patent Application Publication
(10) Pub. No.: US 2004/0111351 A1
(43) Pub. Date: Jun. 10, 2004

(54) Management quality control system, management quality control method, management quality control program, and medium

(75) Inventors: Yuichi Ikeda, Tokyo (JP); Sunao Nishio, Tokyo (JP); Tohru Hemmi, Tokyo (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/652,539

(22) Filed: Aug. 29, 2003

(30) Foreign Application Priority Data
Dec. 6, 2002 (JP) 2002-354967

(51) Int. Cl. G06F 17/60

(52) U.S. Cl. 705/36; 705/1; 705/35

(57) ABSTRACT

The demand of each stakeholder is quantified by setting up and inputting the demand of each stakeholder, using the database of financial data and non-financial data built about the desirable company for each stakeholder and using a quality index formulized by statistics analysis. Furthermore, pluralities of project management plans are set up and inputted, and project management plans, such as a profit and economic value added, are predicted by the simulation according to the project management plan, and an overall quality index, the weight of which is classified by a degree of importance of each stakeholder, is obtained, to thereby choose the project management plan for maximizing a shareholder value based on the overall quality index.

### FIELD OF THE INVENTION

This invention relates to a management quality control system and method for evaluating project sections that belong to the company, and for evaluating a new project in case of undertaking the new project.

### BACKGROUND OF THE INVENTION

In order to respond to the globalization of management, the motion to adopt the concept of corporate governance in management has spread. An idea that a company should be managed, satisfying various persons concerned (stakeholders), such as employees and creditors, so that a shareholder value may be maximized is the main point of corporate governance. On present showing, argument stops at a qualitative range. However, a management method based on a quantitative index is required for governing a corporation efficiently. The following conventional technology is mentioned as a management control or control system. (For example, see JP-A-2001-357178, Paragraphs 0008 to 0014 and JP-A-2002-92282, Paragraphs 0006 to 0026). JP-A-2001-357176 discloses a technology about a management control method for selecting an important theme on management by checking the level and classifying the weight of each stake-holder's degree of importance according to the level, by industrial classification, scale, and achievements, to thereby choose the important theme on management. Also, JP-A-2002-92282 discloses a technology about control of decision-making in plan, execution and check stages, wherein the activity of the whole company or the specific activity in the company is regarded as a project, and the appropriate activity for fulfilling the project can be controlled and evaluated.

However, in such conventional technology, since diagnosis of question matters about the diagnostic item for the principles of management, for personnel, for merchandize or the like is performed based on a reply to question matters by industrial classifications, scale, and achievement, it becomes qualitative and subjective judgment. Therefore, there is raised a problem such that the viewpoint of corporate governance of maximizing a shareholder value, while considering stakeholders involved in the company or its project, is not clearly reflected. Here, the stakeholders include stockholders, creditors, managers, and employees, or the like.

### SUMMARY OF THE INVENTION

Then, an object of this invention is to provide a management quality control system and its method capable of choosing a project management plan for maximizing a shareholder value, while considering the stakeholders with a degree of importance determined by a manager by formulizing the quality index capable of quantifying a demand of each stakeholder.

In a management quality control system and method of this invention, a demand of each stakeholder is set and inputted to quantify, using a quality index formulized by statistics analysis by using database of financial data and non-financial data that builds a preferential company for each stakeholder. Furthermore, a manager sets up and inputs pluralities of project management plans, taking business conditions into consideration. This makes it possible to predict project management plans, such as a profit and economic value added, by the Monte Carlo simulation, to obtain the overall quality index that classifies the weight of each stake holder's degree of importance determined by the manager according to the project management plan, and to choose the project management plan for maximizing the shareholder value based on the overall quality index.

### BRIEF DESCRIPTION OF THE DRAWINGS

FIG. 1 is a view showing the relation between the composition of a management quality control system according to the embodiment 1 of this invention, and each composite element.

FIG. 2 is a view showing a formulization method of a quality index.

FIG. 3 is a view showing a table composition of financial and non-financial data.

FIG. 4 is a view showing an example of an input of a project management plan (common portion) input screen.

FIG. 5 is a view showing an example of an input of a project management plan (every technique) input screen (standard plan).

FIG. 6 is a view showing an example of an input of a project management plan (every technique) input screen (operating strengthening).

FIG. 7 is a view showing an example of an input of a project management plan (every technique) input screen (cost reduction A).

FIG. 8 is a view showing an example of an input screen of a project management plan simulation part.

FIG. 9 is a view showing an example of a display in a display part of a simulation result.

FIG. 10 is a view showing an example of an input of stake-holders' degree of importance input part.

FIG. 11 is a view showing an example of the result displayed in the display part of an overall quality index and a project management plan.

### PREFERRED EMBODIMENT OF THE INVENTION

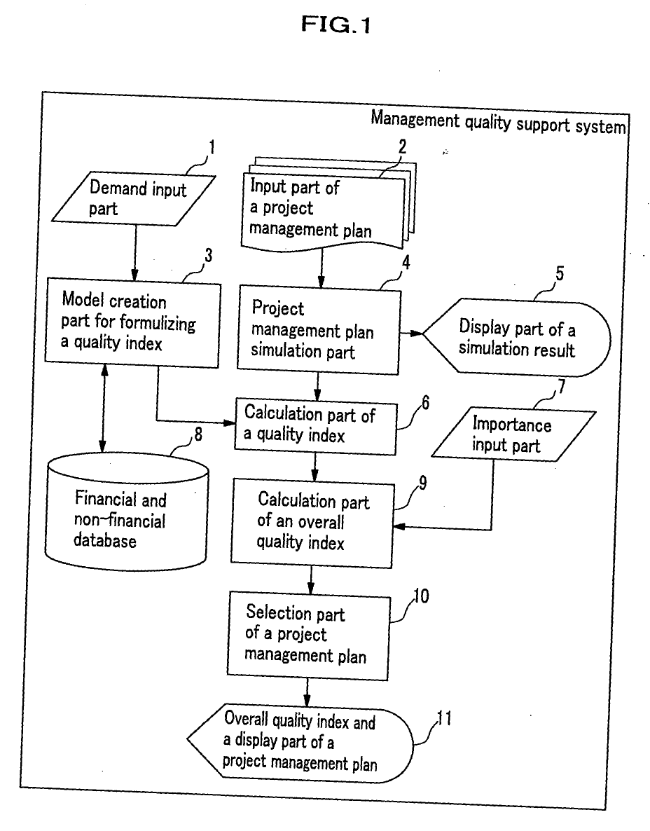

Hereafter, with reference to the drawings, a management quality control system and method of this invention will be explained. FIG. 1 is a view showing the relation between the composition of the management quality control system according to the embodiment 1 of this invention, and each composite element. The management quality control system of this invention is a system that chooses a project management plan for maximizing a shareholder value by formulizing a quality index which can quantify a demand of each stakeholder about a company or its project, while considering stakeholders with degree of importance of each stake holder's quality index determined by managers.

As shown in FIG. 1, the management quality control system includes demand input part 1 that inputs a demand of stakeholders; model creation part 3 that formulizes a quality index so that a demand of the stakeholder may be satisfied; financial and non-financial database 8 that puts the financial and non-financial data about a desirable company for the stakeholders in a database; input part 2 that inputs pluralities of project management plans in consideration of business conditions thereof; project management plan simulation part 4 that predicts the project management plans, such as a profit and economic value added according to the project management plan; display part 5 that displays a simulation result; calculation part 6 that calculates a quality index; degree of importance input part 7 that inputs the stake-holder's degree of importance; calculation part 9 that calculates an overall quality index that classifies the weight of the quality index with the stakeholders' degree of importance; selection part 10 of the project management plan that maximizes the overall demand of the stake-holders; and display part 11 that displays the overall quality index and the project management plan.

In addition, by use of a computer, each of the above composition is achieved by the program of a computer as a management quality control program. Moreover, the management quality control program is recordable on a recording medium.

A system flowchart for processing between each composite element described above by computer is shown in FIG. 1. Hereafter, explanation will be given with reference to FIG. 1. First, a demand of a stakeholder is inputted from the stakeholder's demand input part 1. This means that actual or potential demand is grasped from the stakeholder's viewpoint. As the typical stakeholders, stockholders, creditors, administrators (managers), employees, or the like can be listed. In addition, as an example of a demand of each stakeholder, it is considered as “I want a stock price to go up” for a stockholder, “I want to be refunded as planned” and “I don't want going bankrupt.” for a creditor, “I want to increase profits” “I want a high bonus” and “I want to mitigate risks” for an administrator (manager), “I don't want going bankrupt” and “I want a high salary” for an employee. A creditor, a consumer, a supplier, the government, or the like are raised as other stakeholders. In addition, although not shown, the demand of the stakeholder is shown by a list, and displayed on a screen, so that the input item may be checked, chosen, and inputted by the check box or the like.

Next, in the model creation part 3 for formulizing a quality index, financial and non-financial database 8 about a desirable company for the stakeholder is used, and a quality index is formulized so that the demand of the stakeholder may be satisfied. Here, the quality index serves as a numerical index for quantifying the demand of the stakeholder.

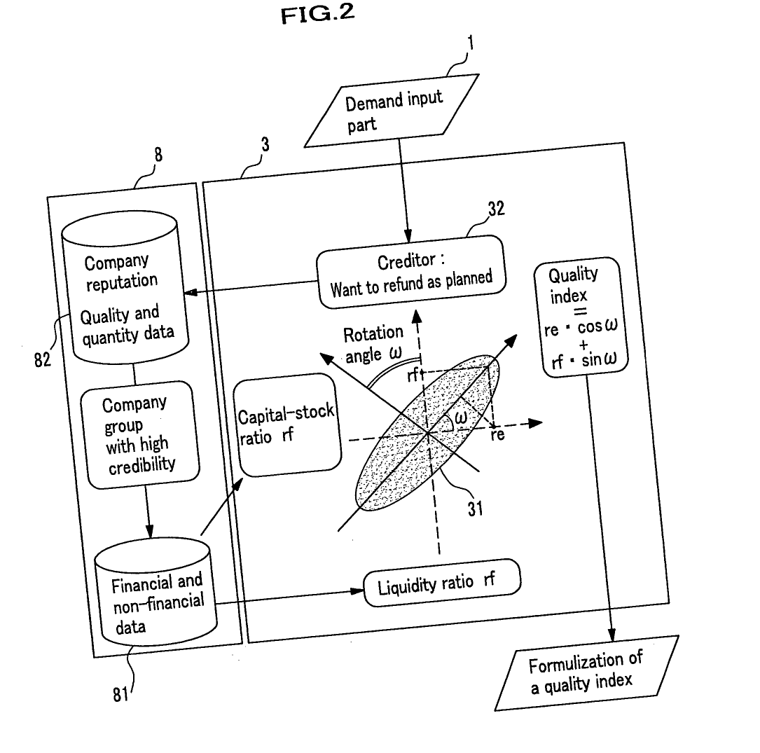

FIG. 2 is a view showing the formulization method of the specific quality index. The specific procedure of formulization will be explained below, assuming a demand such as “I want a loan refunded as planned” is inputted from the stake holder's demand input part 1 as a demand of a creditor into the model creation part 3 for formulizing a quality index so that the demand of the stake holder may be satisfied.

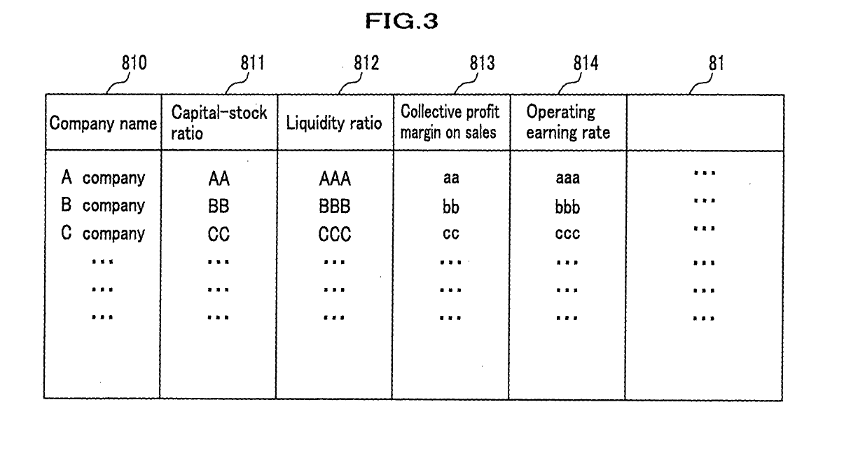

The demand is transmitted to the financial and non-financial database (processing) 8 from the model creation part 3 for formulizing a quality index. In the financial and non-financial database (processing) 8, a company group with high credibility, that is, a company with a large chance of refunding as planned is sorted out from company reputation quality and the fixed quantity data 82 where evaluation of the company is put in a database. Then data about the company group that is chosen from the financial and non-financial data 81 is returned to the model creation part 3 for formulizing a quality index. As for the data, the following indices are mentioned, for example. In addition, the financial and non-financial database 8 put the track record data of the old financial and non-financial state of the company group with high credibility in a database beforehand. FIG. 3 is a view showing the table composition of the financial and non-financial data 81. The data consists of data where company name 810 with high credibility is made to correspond to indices, such as capital-stock ratio 811, liquidity ratio 812, collective profit margin on sales 813, and operating earning rate 814.

Next, each index will be shown below.

As an example of the index showing profitability, there is formula (1) to formula (4) as follows.

Gross profit margin on sales=a gross margin/sales (1)

Operating earning rate (Earnings Before Interest and Taxes EBIT)=

operating profit/sales (2)

Pretax-profit-to-sales ratio=ordinary profit/sales (3)

Current term net profit sales ratio=current term net profit/sales (4)

As an example of the index showing growth possibility, there is formula (5) to formula (6)

Sales growth rate=increase amount of sales/sales of base year (5)

Gross-assets growth rate=increase amount of the gross-assets/gross-assets

balance of base year (6)

As an example of the index showing efficiency, there is formula (7) to formula (11).

Collective assets turnover ratio=sales/collective assets (7)

Trade receivable turnover period=trade receivable/(sales/365) (8)

Stock turnover period=inventory assets/(sales/365) (9)

Purchase debt turnover period=purchase debt/(sales/365) (10)

Tangible fixed assets turnover rate=sales/tangible fixed assets (11)

As an example of the index showing stability, there is formula (12) to formula (17).

Capital-stock ratio=capital stock/collective assets (12)

Liquidity ratio=current assets/current liabilities (13)

Cash-to-current-liabilities ratio=current fund (deposit+trade receivable+

investment securities)/current liabilities (14)

Fixed asset to net worth ratio=fixed assets/capital stock (15)

Fixed-length term precision=fixed-assets/(capital stock+fixed liabilities) (16)

Interest coverage ratio=(operating profit+finance income)/interest

expense (17)

As an example of the index showing comprehensive power, there is formula (18) to formula (20).

FIV (R)=Net Operating Profit After Tax−weighted capital cost×capital

invested (18)

ROE (return on equity)=current net earnings/capital stock (19)

ROA (return on asset)=(current profits+interest expense)/collective

assets (20)

In the model creation part 3 for formularizing a quality index so that a demand of the stakeholder may be satisfied, using the index, by statistics analysis such as a primary component analysis, the quality index is formulized as primary combination of the index so that a demand of the stakeholder may be expressed best. In the formulization of the quality index, data of a company group for the demand of the stakeholder returned from the financial and non-financial database 8 is plotted on an axis of coordinates, the distribution of a company group is drawn, coordinates conversion (rotation) is carried out so that the width of the distribution may become the longest, and the direction where width becomes the longest is defined as a quality index. The same applies to when consisting of many indices.

An example where two indices are used is shown in FIG. 2. In this example, distribution of the data of the company group is drawn on plan surface stretched by such two quantity by standardizing so that capital stock ratio re and liquidity ratio rf may become average 0 and standard deviation 1. In this example, since two kinds of indices are shown, that is, the capital-stock ratio re and the liquidity ratio rf, the data of a company group is plotted in two dimensions. Sign 31 shows a plotted range in FIG. 2. According to the distribution of this data, coordinates rotation is performed so that the width of the distribution may become the longest. That is, this is the statistical processing method based on the track record data of the company group included in the financial and non-financial database 8. When the capital-stock ratio re and the liquidity ratio rf are distributed as shown in the figure (range of the sign 31 of FIG. 2) and the rotation angle by coordinates rotation is set to ω as shown in FIG. 2, the quality index can be expressed as re·COS ω+rf·sin ω. Since the direction (referred to as a first primary components) where the width of the distribution becomes the longest is used for the quality index, data of a top-rated company is chosen statistically here. Generally when obtaining the data from N indices, it becomes n dimensions and a rotation angle becomes n pieces. This is expressed by general formula as the following formula (A). If Z, and the financial and non-financial data are set to Xi (i=1, . . . , n), the quality index Z can be expressed by primary combination of the financial and non-financial data Xi.

Z=a₁X₁+a₂X₂+Λ+aₙXₙ (A)

Coefficient a is obtained by solving the following characteristic value equation (B). The first primary component is the coefficient a corresponding to the largest characteristic value λ.

$$( \begin{matrix}{r}_{11} & Λ & {r}_{1 n} \\ M & & M \\ {r}_{n1} & Λ & {r}_{nn}\end{matrix} ) ( \begin{matrix}{a}_{1} \\ M \\ {a}_{n}\end{matrix} ) = λ ( \begin{matrix}{a}_{1} \\ M \\ {a}_{n}\end{matrix} ) \qquad ( B )$$

However, r is a correlation coefficient defined by the following formula. Moreover, E expresses the expected value in terms of probability.

rᵢⱼ=E[(rᵢ−E(rᵢ))(rⱼ−E(rⱼ))]/{square root over (E[(rᵢ−E(rᵢ))²]E[(rⱼ−E(rⱼ))²)}] (C)

In addition, obtaining the formula of the quality index is called as modeling. An example of a creditor's quality index was shown as a creditor in FIG. 2. However, the same is true of stockholders, administrators (managers), employees, or the like, who are stakeholders, and the quality index thereof can be obtained.

Thereby, a demand of each stakeholder can be formulized as a quality index, and can be judged quantitatively and objectively.

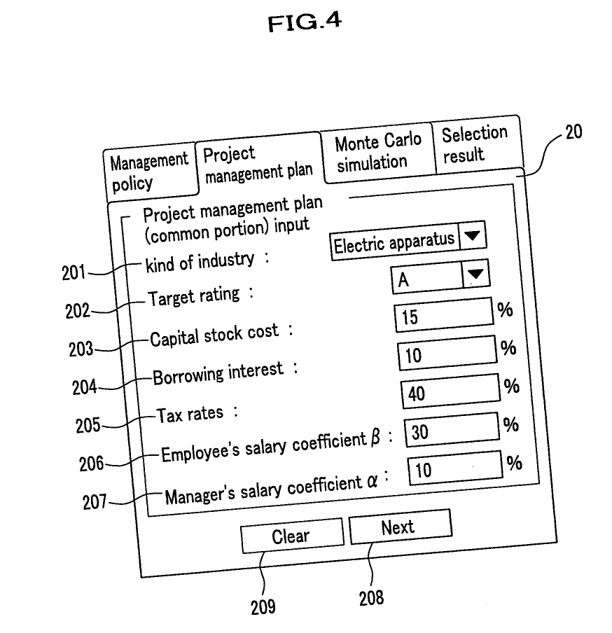

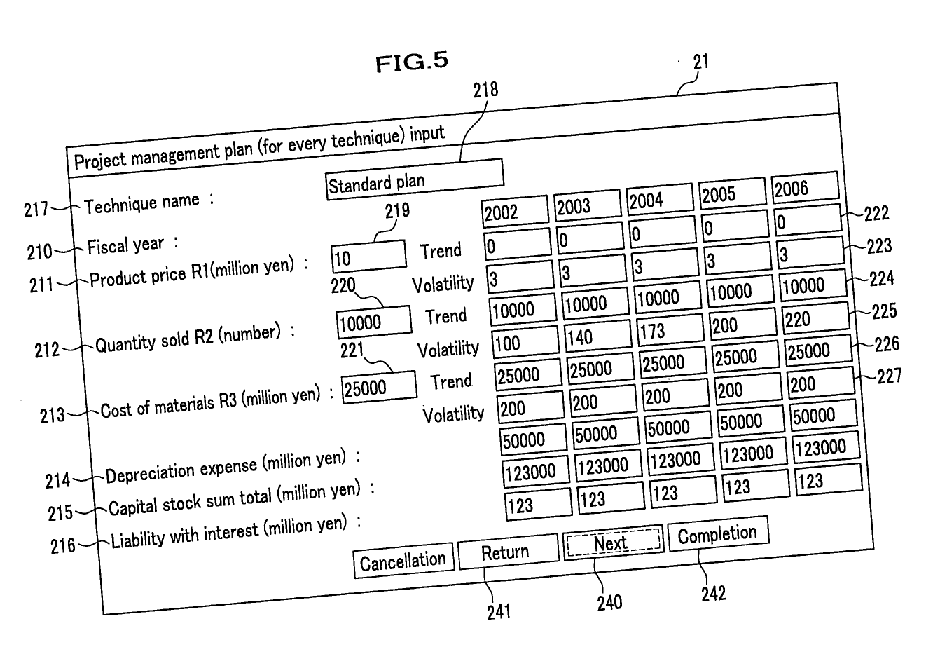

Next, the data about a project management plan is inputted from project management plan input part 2 in consideration of business conditions. This data is inputted for every common part and every technique. FIG. 4 is a view showing an example of an input of the project management plan (common part) input screen 20. The common part is a portion of common conditions to various kinds of techniques (technique) as will be described hereafter when furthering the project management plan. The common part of pluralities of project management plans to be discussed is inputted from the project management plan (common part) input screen 20. In FIG. 4, kind of industry 201, target rating 202, the capital stock cost 203, borrowing rate 204, tax rate 205, salary coefficient β 206 of employees for computing a salary of employees and managers, and salary coefficient α 207 are displayed. The target rating 202 is target rating to the project management plan, and if the project is the company of a single specialty, it means company rating. The capital stock cost 203 means the ratio of net assets or equity capital in the project management plan. Also, the borrowing rate 204 is the ratio of the borrowing rate in the cost of the project management plan. Employee's salary coefficient β 206 and manager's salary coefficient α 207 are coefficients of formula (28) and (29) as will be described hereafter. For jump to FIG. 5, button “next” 208 is pressed after inputting these data in a common part.

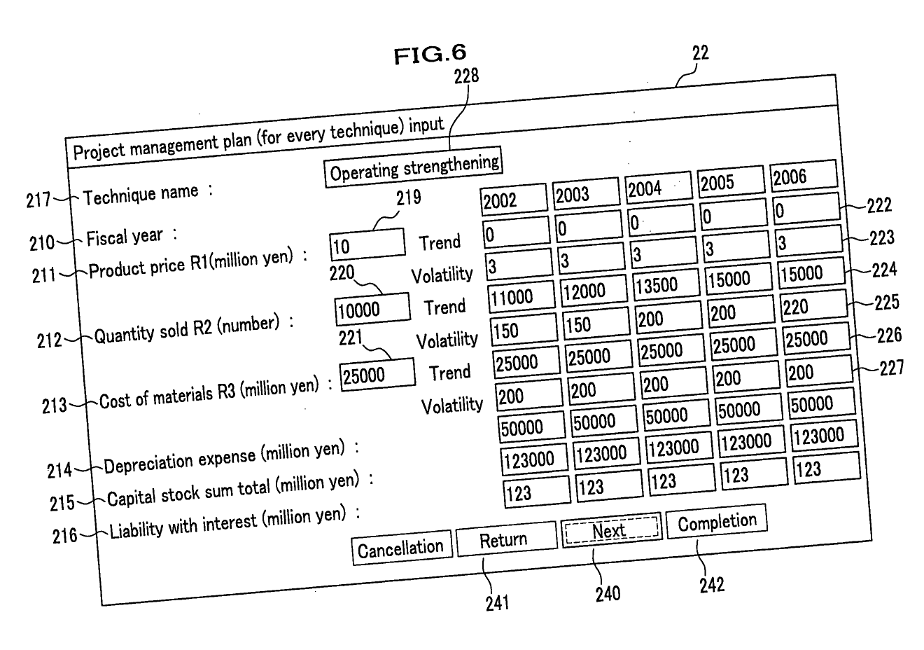

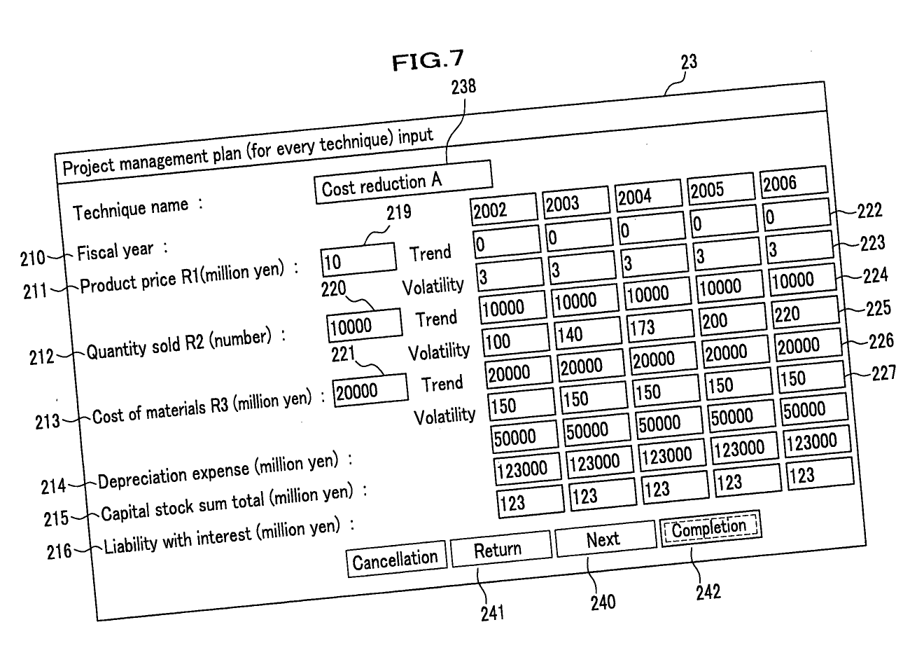

FIG. 5 is a view showing an example of an input of the project management plan (every technique) input screen 21. When examining pluralities of project management plans, an operating strengthening measure or a cost reduction policy, which is related to a management policy, is called as technique. Data according to the technique is inputted from the project management plan (for every technique) input screen 21 in consideration of project conditions. In FIG. 5, starting with initial values 219, 220, and 221 of technique name 217, fiscal year 210, product price R1 (211), quantity sold R2 (212), and cost of materials R3 (213) as specific items for input, for example, trend (inclination) of a product price R1 (222), volatility (blur widths) 223, trend (inclination) of quantity sold R2 224, volatility (blur widths) 225, trend (inclination) of the cost of materials R3 226, volatility (blur widths) 227, depreciation expense 214, capital stock total 215, and liabilities with interest 216 for every fiscal year are listed. In FIG. 5, the standard plan 218 is inputted as a technique name of the project management plan. In addition, standard plan 218 may be defined as not especially generated matter but generally generated matter. If button “next” 240 of the input part of the project management plan (for every technique) is pressed, the input screen for input of the following technique appears. FIG. 6 is a view showing an example of an input of the project management plan (for every technique) input screen 22 inputted into input data as a technique reflecting the operating strengthening 228. In the standard plan 218 shown in FIG. 5, the trend (inclination) 224 of the quantity sold R2 and volatility (blur widths) 225 is increased as operating strengthening. Furthermore, if button “next” 240 is pressed, the input screen for input of the following technique appears. FIG. 7 is a view showing an example of an input of the project management plan (for every technique) input screen 23 inputted into input data as a technique reflecting cost reduction A238. In the standard plan 218 shown in FIG. 5, the trend (inclination) 226 and volatility (blur widths) 227 of the cost of materials R3 are reduced. Further, the cost of materials R3 can be changed into different input data from cost reduction A (238), so as to be newly inputted as cost reduction B (not shown), for example. After inputting the input item for every technique, button “completion” 242 is pressed and the input of the project management plan is ended. In addition, according to the selection of technique, input items other than product price R1 (211), quantity sold R2 (212), cost materials R3 (213), or the like may be contained as shown in FIG. 5 to FIG. 7.

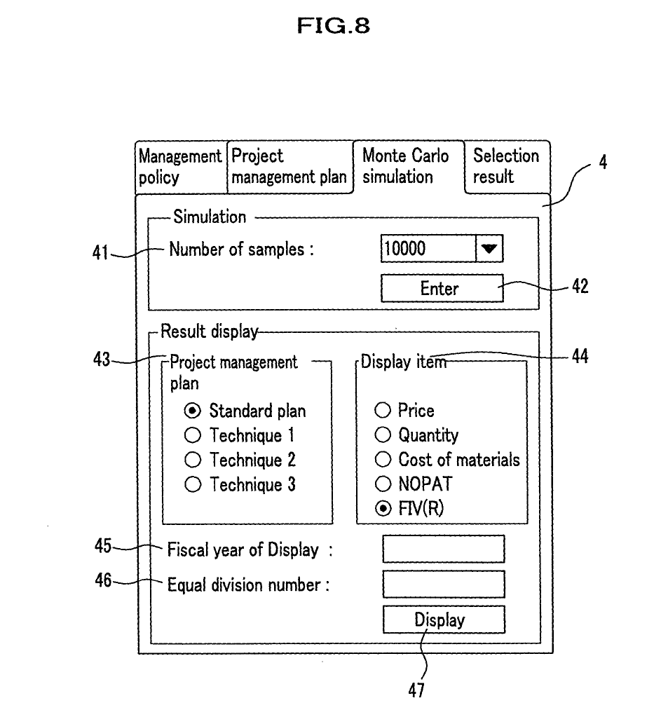

Next, in project management plan simulation part 4 for predicting a profit, economic value added or the like, a simulation of each project management plan (technique) is performed according to the project management plan by methods, such as the Monte Carlo simulation. FIG. 8 is a view showing an example of an input screen of the project management plan simulation part 4. In the project management plan simulation part 4 for predicting a profit, economic value added, or the like, simulation is performed by inputting or choosing 41 samples of the Monte Carlo simulations, and by pressing button “execution” 42 according to the project management plan. In the example shown in FIG. 8, 41 samples means 10000 times simulations. This is shown in FIG. 5 in such a way that 5 fiscal years from the 2002 fiscal year to the 2006 fiscal year are listed as a sample to simulate 10000 times. A column of the result display includes a standard plan, technique 1, technique 2, and technique 3, and a column of display item 44 includes a price (selling price), quantity (quantity sold), cost of materials, economic benefits FIV (R) (Future Inspiration Value) as will be described hereafter. The standard plan and the FIV (R) are chosen here. Moreover, display fiscal year 45 is a fiscal year for displaying the result of the simulation. Equal division number 46 is a divided value from the minimum value to the maximum value of the graph for displaying the result of the simulation. When there are few samples, the equal division number can be made small, so as to be made legible. When button “display” 47 is pressed, the result of the simulation is displayed. Concrete calculation of the Monte Carlo simulation can be performed as follows, for example. Selling price R1, quantity sold R2, and cost of materials R3 are stochastic processes, and are expressed with the geometric Brown process using Trend μ, and Volatility ρ which are obtained in the project management plan. If the selling price R1 is exemplified, the Monte Carlo simulation will generate the sample process of the selling price R1 as the following formulas.

R1(t+1)=R1(t)+ΔR1(t) (21)

ΔR1(t)=R1(t){μ(t)Δt+ρ(t)ε\sqrt{Δt}} (22)

Here, ε is a standard regular random number. This is the random number of average value 0, and standard deviation 1. The random number is generated 5 times by 1 time of a sample (from the 2002 fiscal year to the 2006 fiscal year), and the selling price R1 is simulated. Also, t is time and Δ is variation. Sample process of quantity sold R2 and cost of materials R3 is generable by the same method also.

Next, in calculation part 6 of a quality index, in order to compute the sample process of the FIV (R) using the sample process of the selling price R1 generated by the above-described method, the quantity sold R2, and the cost of materials R3, the sample process of the Net Operating Profit After Tax NOPAT is computed first. NOPAT can be expressed by the following formula (23).

NOPAT=(ordinary profit+interest expense)×(1−tax rates) (23)

Ordinary profit is the following formula (24) here.

Ordinary profit=sales-depreciation expense−manufacture cost (24)

Moreover, sales, a depreciation expense, and manufacture cost can be expressed by formula (25), (26), and (27), respectively.

Sales=selling price R1×quantity sold R2 (25)

Depreciation expense=the amount of capital investment/depreciation period (26)

Manufacture cost=employees' salary+cost of materials (27)

Employees' salary=β×sales (28)

Economic benefits (Future Inspiration Value) FIV (R) are computed according to the formula (18) described above.

Economic benefits FIV (R)=Net Operating Profit After Tax−weighted average cost-of-capital×invested capital (18)

Here, the weighted average cost of capital of a formula (18) can be obtained by the following formula (18a) and (18b).

Weighted average cost-of-capital={rate of capital stock cost×capital stock

sum total×(1−tax rates)/invested capital}+{borrowed interest rate×

liability with interest/invested capital} (18a)

Invested capital=capital stock sum total+liability with interest (18b)

Accordingly, the economic benefits (FIV (R) can be obtained from sample process, such as these formulas and the selling price R1, the quantity sold R2, and the cost of materials R3.

Moreover, managers' salary shall be interlocked with the economic benefits FIV (R) produced by project instead of cost as follows.

Managers' salary=α×FIV (R) (29)

Other quality indices from Formula (1) to (20) are computable directly from the input value of the project management plan, or FIV (R) can be obtained by using the same method as described above such as sample process.

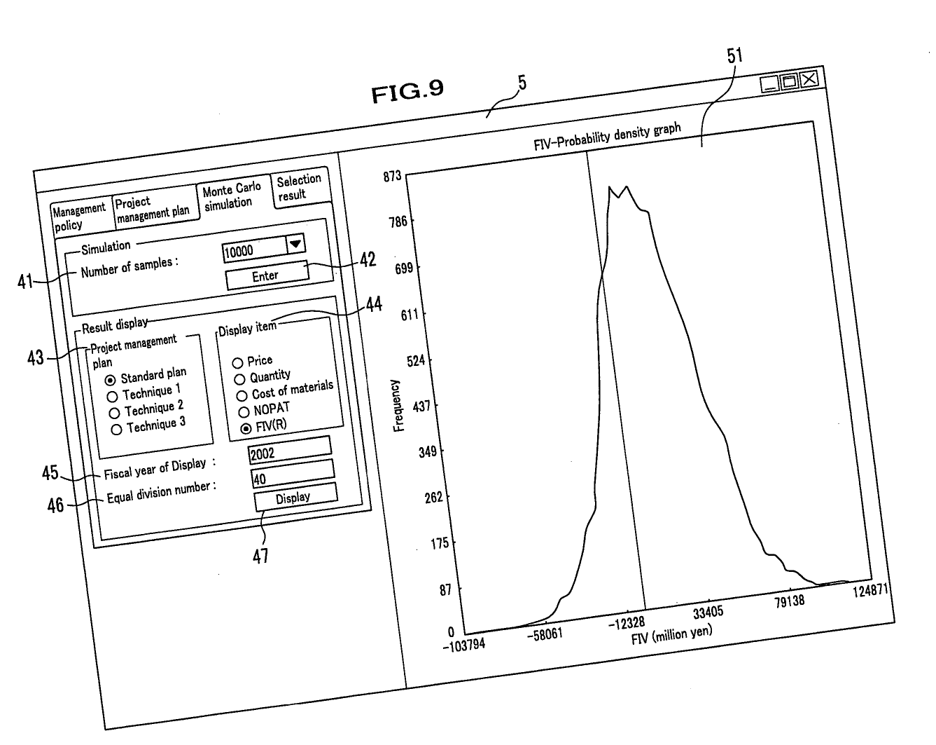

The result of the above-described Monte Carlo simulation is displayed in the display part 5 of the simulation result. As for each project management plan, the selling price of each fiscal year, a quantity sold, the cost of materials, the Net Operating Profit After Tax NOPAT, the economic benefits, that is, Future Inspiration Value (FIV (R)), etc. are displayed here. FIG. 9 is a view in the display part 5 of the simulation result showing an example of the display. In FIG. 9, 41 samples, selected project management plan 43, display item 44, display fiscal year 45, and equal division number 46 are displayed on the left-hand side of a screen, and graph 51 of the display item chosen is displayed on the right-hand side of the screen. In FIG. 9, FIV (R) is displayed as a display item. In this simulation, frequency distribution is highest around 27,000 (million yen) of FIV (R). Conversely, possibility of the project management plan is highest at 27,000 (million yen) of FIV (R).

Thereby, it can be said that the project management plan is trustworthy.

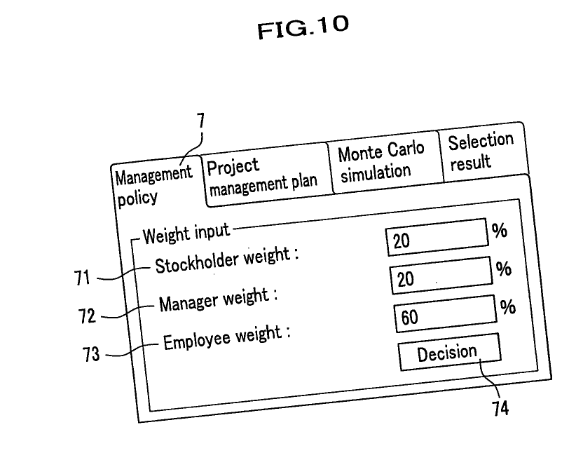

Next, each stakeholder's degree of importance is inputted in stakeholders' degree of importance input part 7. Here, the degree of importance means a setup of the management quality aimed at by managers to clarify the aim of the management. FIG. 10 is a view showing an example of an input in the stakeholders' degree of importance input part 7. In the degree of importance input part 7 shown in FIG. 10, stockholders, managers, and employees are exemplified as stakeholders. In FIG. 10, stockholder weight 71, managerial weight 72, and employee weight 73, that express the degree of importance of each stakeholder, are inputted so that the sum totals may become 100%, and button “decision” 74 is pressed.

This degree of importance is effective in clarifying the aim of managers' project management plan.

Furthermore, in calculation part 9 for classifying the weight of the quality index by stakeholders' degree of importance, an overall quality index of each project management plan (technique) is computed by classifying the weight of quality index of each stakeholder. The overall quality index can be expressed as the following formula (30), when the stakeholders are stockholders, managers, and employees.

Overall quality index=W1×stockholder's quality index+W2×

manager's quality index+W3×employee's quality index (30)

The stockholders' quality index, the managers' quality index, and the employees' quality index here can be obtained by the formulization method of the quality index on the base of the statistics technique such as a primary component analysis shown in FIG. 2, respectively, so that a demand of each stakeholder may be satisfied. As one form, as described above, economic benefits (Future Inspiration Value) FIV (R)=Net Operating Profit After Tax−weighted average cost-of-capital×invested capital of formula (18) is used for the stockholder's quality index, salary of employees=β×sales of formula (28) is used for the employee's quality index, and salary of managers=α×FIV (R) of formula (29) is used for the manager's quality index.

In the selection part 10 of the project management plan for maximizing the overall demand of the stakeholder, the project management plan with largest overall quality index computed by the above-described method, is chosen.

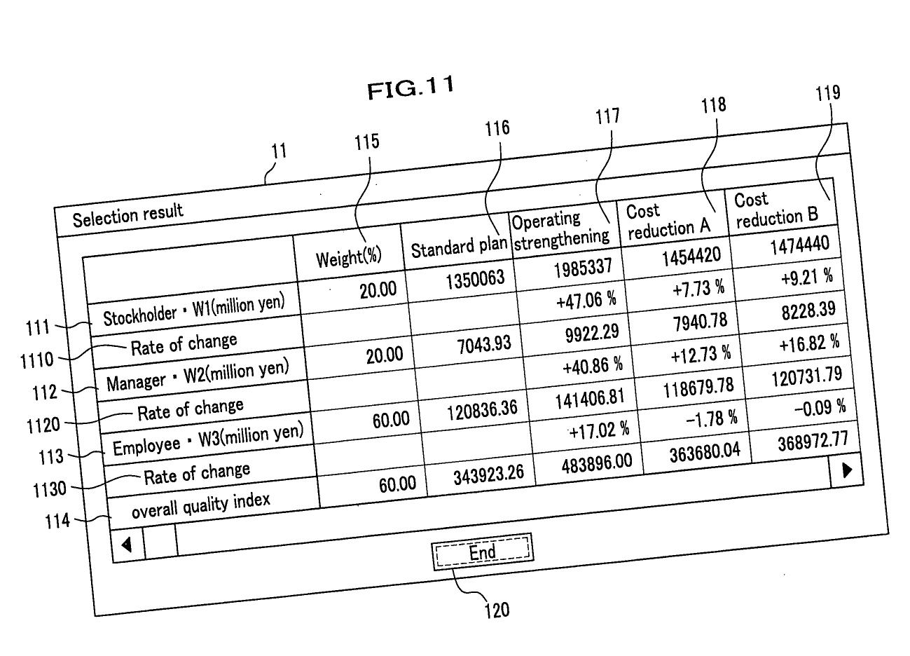

Finally, in display part 11 of the overall quality index and project management plan, each project management plan, each stake-holder's quality index and the overall quality index are displayed. FIG. 11 is a view showing an example of the result displayed in the display part 11 of the overall quality index and the project management plan. In FIG. 11, the project management plan that adopts techniques, such as weight 115 and standard plan 116, operating strengthening 117, cost reduction A118, and cost reduction B119, in the direction of a column is displayed. Also, stock holder S, W1 (111), managers, W2 (112), employees, W3 (113) displaying quality index×weight (W1, W2, W3) of stockholders, managers, employees who are stakeholders, and the rates of change 1110, 1120, and 1130 from a standard plan and the overall quality index 114 are displayed in a line direction. In the example shown in FIG. 11, the overall quality index 114 results in largest by adopting operating strengthening 117 as a technique. Accordingly, the project management plan can satisfy the demand of each stakeholder to the maximum by adopting the operating strengthening 117 as a technique. Finally when button “end” 120 is pressed, a series of operation is completed.

Thereby, the project management plan can be determined by choosing the project management plan that allows the overall quality index to become maximum so that the overall demand of the stakeholders may become maximum.

This invention as described above is not limited to the above modes of embodiment, and can be varied in modes freely within the gist of the invention. For example, a project plan determination control system for determining a project plan and a management consulting control system for performing diagnosis of corporate management can be carried out using the quality index and an overall quality index of the above-described stakeholders.

What is claimed is:

1. A management quality control system for evaluating at least one of a company and a project undertaken by the company in consideration of a demand of stakeholders of at least one of a company-related demand and a project-related demand of stakeholders, comprising:
a demand input part for inputting the demands of the stakeholders;
a project management plan input part for inputting a project management plan;
a model creation part for formularizing a quality index so that the demands of the stakeholders may be satisfied;
a project management plan simulation part for simulating the project management plan inputted in the project management plan input part;
a simulation result display part for displaying a simulation result performed in the project management plan simulation part;
a quality index calculation part for calculating a quality index of the project management plan using the formularized quality index created by the model creation part;
a degree-of-importance input part for inputting degrees of importance assigned to each type of the stakeholders;
a financial and non-financial database for storing financial and non-financial data of a desirable company for the stakeholders;
an overall-quality-index calculation part that classifies the weight of each stakeholder's degree of importance and calculates an overall quality index thereby;
a display part that displays the overall quality index calculated in the overall-quality-index calculation part; and
a project management plan display part that displays the project management plan selected based upon the overall quality index.

2. A management quality control system for evaluating at least one of a company and a project undertaken by the company in consideration of a demand of stakeholders of at least one of a company-related demand and a project-related demand of stakeholders, comprising the steps of inputting the demands of the stakeholders; obtaining financial and non-financial data from a database in which the financial and non-financial data of a company desirable for the stakeholders is stored; and quantifying and formularizing the demands of the stakeholders based upon the demand and the financial and non-financial data obtained to calculate the formularized management quality index.

3. A management quality control method as claimed in claim 2, further comprising the steps of inputting the demands of the stakeholders; and simulating the project management plan, wherein the project management plan is predicted by simulation according to pluralities of project management plans set up in consideration of business conditions, and also the quality index of stakeholders is calculated using the formularized quality index.

4. A management quality control method as claimed in claim 2, further comprising the steps of inputting the demands of the stakeholders; obtaining an overall quality index for classifying the weight of the stakeholders' quality index by the stakeholders' degree of importance; and selecting the project management plan based on the overall quality index.

5. A management quality control method as claimed in claim 2, wherein the degree of importance of said each stakeholders, the simulation result of the project management plan, the overall quality index, and the management plan selected by the overall quality index are outputted.

6. A management quality control program for management quality control used for the management quality control system as claimed in claim 1.

7. A recording medium capable of computer reading wherein a management quality control program described in claim 6 is recorded.

8. A management quality control method as claimed in claim 3, further comprising the steps of inputting the demands of the stakeholders; obtaining an overall quality index for classifying the weight of the stakeholders' quality index by the stakeholders' degree of importance; and selecting the project management plan based on the overall quality index.

9. A management quality control method as claimed in claim 3, wherein the degree of importance of said each stakeholders, the simulation result of the project management plan, the overall quality index, and the management plan selected by the overall quality index are outputted.

10. A management quality control method as claimed in claim 4, wherein the degree of importance of said each stakeholders, the simulation result of the project management plan, the overall quality index, and the management plan selected by the overall quality index are outputted.
